(19) United States
(12) Patent Application Publication
(10) Pub. No.: US 2006/0025916 A1
(43) Pub. Date: Feb. 2, 2006

(54) Vehicle control system having atmospheric pressure estimating function

(75) Inventors: Makoto Tanaka, Kariya-city (JP); Hidehiko Asama, Toyota-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/171,255

(22) Filed: Jul. 1, 2005

(30) Foreign Application Priority Data
Jul. 30, 2004 (JP) 2004-222929

(51) Int. Cl. G06F 7/00

(52) U.S. Cl. 701/72; 701/84

(57) ABSTRACT

A vehicle control system has an electronic control unit for controlling an engine based on various operation parameters detected by a throttle sensor, an intake pressure sensor, an accelerator sensor, a vehicle speed sensor and the like. The electronic control unit is programmed to calculate an inclination of a travel road of the vehicle and a travel distance of the vehicle, and then an atmospheric pressure as a function of the inclination and the travel distance. The electronic control unit is further programmed to calculate upper and lower limits based on the inclination and the travel distance thereby to guard the atmospheric pressure from exceeding above and below the upper and lower limits, respectively.

### CROSS REFERENCE TO RELATED APPLICATION

This application is based on and incorporates herein by reference Japanese patent application No. 2004-222929 filed on Jul. 30, 2004.

### FIELD OF THE INVENTION

The present invention relates to a vehicle control system having an atmospheric pressure estimating function.

### BACKGROUND OF THE INVENTION

An atmospheric pressure changes with an altitude. The density of air sucked into an engine of a vehicle also changes with an altitude. It is therefore necessary to correct an air-fuel mixture ratio control parameter based on an altitude to improve control accuracy of an air-fuel ratio control system for an engine. An atmospheric pressure sensor adds cost if provided to detect an atmospheric pressure.

JP 2000-345910A therefore proposes to estimate an atmospheric pressure based on detection outputs of a throttle sensor and an intake pressure sensor, so that the atmospheric pressure may be determined without an atmospheric pressure sensor. It is desired to improve accuracy in atmospheric pressure estimation by taking changes in altitudes of a road on which a vehicle travels, because the atmospheric pressure changes mostly with altitudes during a vehicle travel. For the altitude detection or estimation, an additional sensor will have to be provided resulting in addition of costs.

### SUMMARY OF THE INVENTION

It is therefore an object of the present invention to provide a vehicle control system, which is capable of estimating an atmospheric pressure taking changes in altitudes of a vehicle travel road without additional sensors.

According to the present invention, a torque required by a vehicle driver to control an output torque of a power source is calculated based on a vehicle driver operation. A vehicle travel speed is detected. An inclination of a road which the vehicle travels is estimated based on the required torque and the travel speed. An atmospheric pressure is estimated as a function of the estimated inclination and a vehicle travel distance.

Preferably, the atmospheric pressure is primarily estimated based on a throttle position and an intake air pressure of an engine used as the power source. The estimated pressure is guarded by an upper limit and a lower limit calculated based on the estimated inclination and the travel distance. Alternatively, the estimated pressure is corrected by the estimated inclination and the travel distance.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic view showing a vehicle control system according to an embodiment of the present invention;

FIG. 2 is a block diagram functionally showing atmospheric pressure estimation processing in the embodiment; and

FIG. 3 is a flowchart showing the atmospheric pressure estimation processing executed in the embodiment.

### DETAILED DESCRIPTION OF THE PREFERRED EMBODIMENT

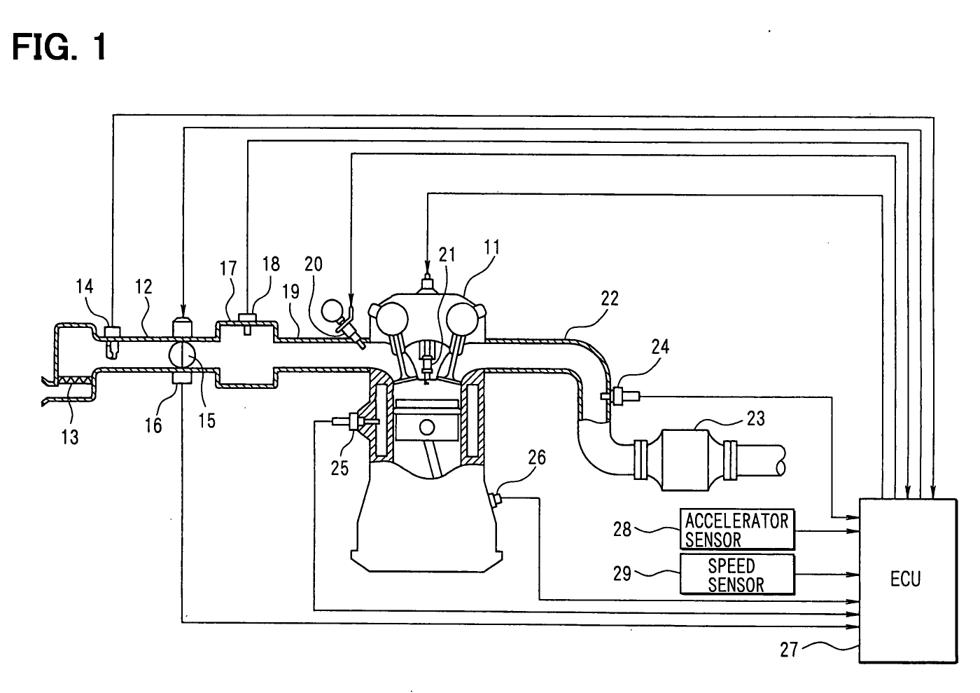

A vehicle control system includes, as shown in FIG. 1, an internal combustion engine 11 having an intake pipe 12, an exhaust pipe 22 and an electronic control unit (ECU) 27.

In the intake pipe 12, an air cleaner 13 is provided at the most upstream side. An airflow meter 14 is provided downstream the air cleaner 13 for detecting an intake airflow quantity Ga. A throttle valve 15 and a throttle sensor 16 are provided downstream the airflow meter 14. The throttle valve 15 is electrically driven by an electric motor to change the intake airflow quantity sucked into the engine 11. The throttle sensor 15 is linked with the throttle valve 15 to detect a throttle valve position (throttle opening degree)Φ.

A surge tank 17 is provided downstream the throttle valve 15. An intake pressure sensor 18 is attached to the surge tank 17 to detect an intake air pressure Pm in the intake pipe 12. The surge tank 17 is connected to intake manifolds 19 of engine cylinders. Fuel injectors 20 are attached to intake manifolds 19 to inject fuel into the cylinders, respectively. Spark plugs 21 are provided on an engine cylinder head to ignite air-fuel mixture in the cylinders, respectively.

In the exhaust pipe 22, a catalyst 23 such as a three-way catalyst is provided to clean CO, HC, NOx and the like in engine exhaust gas. An exhaust gas sensor 24 such as an air-fuel ratio sensor or an oxygen sensor is attached to the exhaust pipe 22 at the upstream of the catalyst 23 to detect air-fuel ratio or oxygen concentration in the mixture supplied to the engine 11.

A coolant temperature sensor 25 and a crank angle sensor 26 are attached to an engine cylinder block to detect engine coolant temperature and a crankshaft rotation position, respectively. An accelerator sensor 28 is linked with an accelerator pedal, which controls the throttle valve position. A vehicle speed sensor 29 is provided to detect a vehicle speed V.

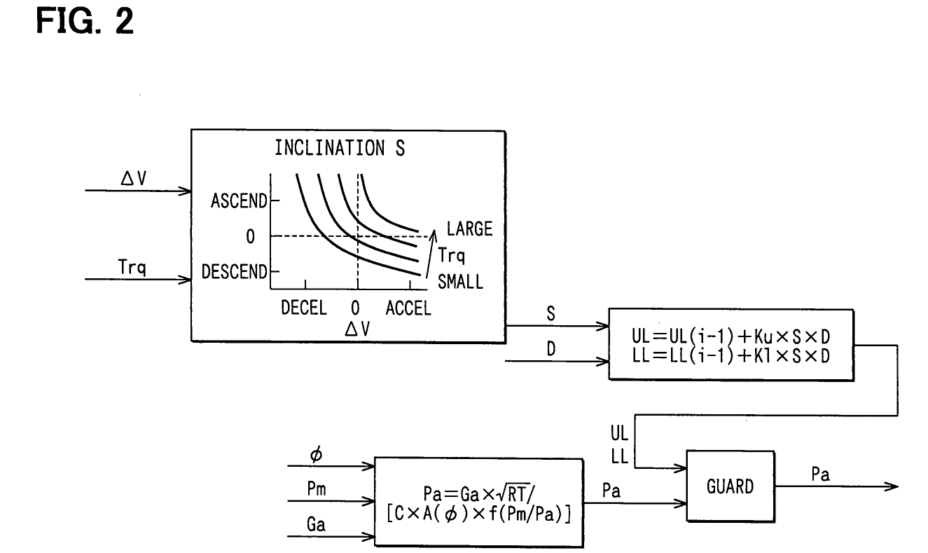

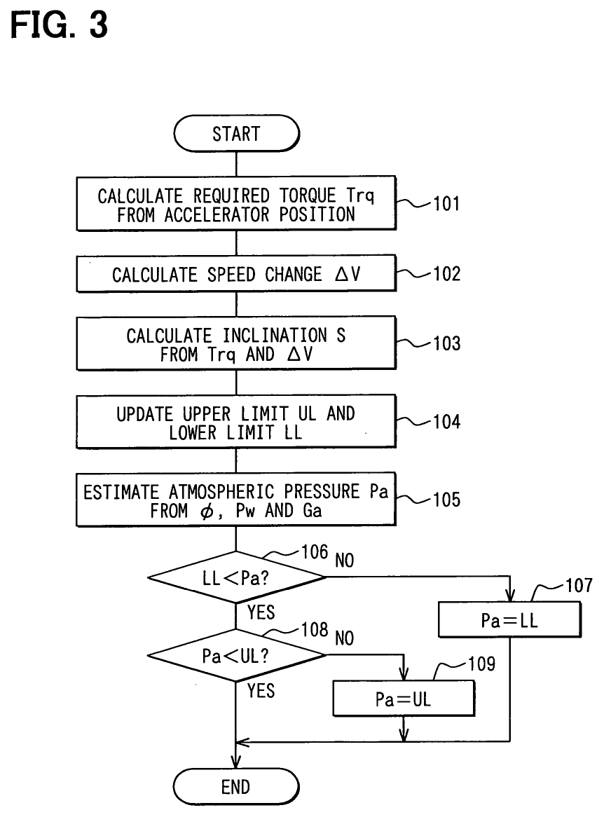

Output signals of these sensors are applied to the ECU 27. The ECU 27 includes a microcomputer, a ROM and the like. The microcomputer controls fuel injection of the injectors 20 and ignition timings of the spark plugs 21 based on the detected parameters by executing an engine control program stored in the ROM. In this fuel injection and ignition timing control, the ECU 27 uses an atmospheric pressure Pa as one parameter in the conventional manner. This atmospheric pressure is estimated by the ECU 27 as shown in FIGS. 2 and 3.

Specifically, as shown in FIG. 2, the ECU 27 estimates the atmospheric pressure Pa based on the detected throttle position φ, the detected intake pressure Pm and the detected intake airflow quantity Ga by using the following theoretical equation.
Ga=C×A(Φ)×Pa×f(Pm/Pa)/(R×T)^{1/2}
C: flow rate coefficient
A(φ): throttle sectional area (sectional area of intake airflow passage variable with throttle position (φ)
R: gas constant
T. intake air temperature

The atmospheric pressure Pa may be estimated in different ways. For instance, it may be estimated from the throttle position φ and the intake pressure Pm. Alternatively it may adopt the intake pressure Pm detected by the intake pressure sensor 18 when the throttle position φ is larger than a predetermined value, because the intake pressure in the surge tank 17 becomes generally equal to the atmospheric pressure.

The ECU 27 guards or limits the atmospheric pressure Pa thus estimated to its upper limit UL and lower limit LL as follows.

The ECU 27 first calculates a vehicle speed V from the output of the crank angle sensor 26 and a speed change ΔV in the vehicle speed V per unit time. It also calculates a required torque Trq from the detected accelerator position and the like. The ECU 27 then estimates a road inclination (slope) S of a vehicle travel road based on the speed change ΔV and the required torque Trq by mathematical calculation or using mapped data. The mapped data may be determined based on road construction design specifications, experimental data or the like and stored in the ROM. As the engine 11 changes its output torque in correspondence with the required torque Trq, the vehicle speed V correspondingly changes. The relation between the required torque Trq and the vehicle speed change ΔV is not fixed but depends on the road inclination. Therefore, the road inclination S can be determined or estimated from the required torque and the speed change ΔV.

After the determination of the inclination S, the ECU 27 calculates or updates the upper limit UL and the lower limit LL in the following manner by correcting the previous upper and lower limits UL(i−1) and LL(i−1) with the road inclination S, a vehicle travel distance D (vehicle speed x time) and correction coefficients Ku and KI.
UL=UL(i−1)+Ku×S×D
LL=LL(i−1)+KI×S×D

It is noted that ‘S×D’ corresponds to an altitude change during a vehicle travels distance D. Thus, the upper limit UL and the lower limit LL are determined to appropriate values in correspondence with the atmospheric pressure, which changes with the altitude change determined by the road vehicle travel distance and the road inclination.

The upper limit UL and the lower limit LL guards the atmospheric pressure Pa estimated as above from too large or too small values. That is, the estimated pressure Pa is limited to the upper limit UL and the lower limit LL even if it becomes larger and smaller than the limit values UL and LL, respectively. Since the limit values UL and LL are variable with the altitude, the atmospheric pressure Pa can be estimated within an appropriate range thereby eliminating improper estimation.

The above estimation processing is executed by the ECU 27 as shown in FIG. 3. This processing is executed periodically during an engine operation.

Each time this processing is initiated, a required torque Trq is calculated, at step 101, based on an accelerator position detected by the accelerator sensor 28. Other parameters may also be used for this calculation. A vehicle speed change ΔV per a certain period is calculated, at step 102, based on two vehicle speeds detected by the speed sensor 29 at the start and the end of the certain period. Then an inclination S of a vehicle travel road is calculated, at step 103, based on the required torque Trq and the speed change AV by using a mapped data for instance.

Two limit values, an upper limit UL and a lower limit LL, are calculated at step 105 by updating respective previous values UL(i−1) and LL(i−1). Specifically the limits UL and LL are calculated as above by using the inclination S, a vehicle travel distance D (travel speed x travel period), and correction coefficients Ku and KI.

An atmospheric pressure Pa is estimated as above, at step 105, as a function of a throttle position φ detected by the throttle sensor 28, an intake air pressure Pm detected by the intake pressure sensor 18 and an intake airflow quantity Ga detected by the airflow meter 14.

Then, at steps 106 and 108, the atmospheric pressure Pa estimated at step 105 is compared with the lower limit LL and the upper limit UL calculated at step 104, respectively. If the atmospheric pressure Pa is smaller than the lower limit LL, the atmospheric pressure Pa is fixed to the lower limit LL at step 107. If the atmospheric pressure Pa is larger than the upper limit UL, the atmospheric pressure Pa is fixed to the upper limit UL at step 109. Thus, the estimated atmospheric pressure Pa is always limited between the two limits UL and LL and guarded against abnormal values. If the estimated atmospheric pressure Pa is within the two limits UL and LL, it is used as a parameter indicative of the atmospheric pressure to control the engine operation.

According to the above embodiment, even if the estimated atmospheric pressure Pa exhibits abnormal values, it is limited to the limit values UL or LL, which are variably determined in correspondence with the altitude. Further, this altitude is estimated based on the vehicle travel distance D and the travel road inclination S. This inclination S is also estimated based on the required torque Trq and the vehicle speed change ΔV. Therefore, no additional sensors such as an atmospheric sensor, an altitude sensor or a slope sensor need be separately provided.

The above embodiment may be modified in various ways. For instance, in place of using the two limits UL and LL, the estimated atmospheric pressure Pa may be corrected by the travel road inclination S and the vehicle travel distance D. The atmospheric pressure Pa may be estimated from the four parameters, that is, travel road inclination S, travel distance D, throttle angle φ and intake pressure Pm. It may also be estimated from only two parameters, that is, travel road inclination S and travel distance D.

The estimation technology of vehicle travel road inclination by using the required torque and the vehicle speed may be applied to control vehicles powered by an electric motor or powered by a combination of an electric motor and a gasoline engine.

What is claimed is:

1. A vehicle control system comprising:
power source means for generating a motive power to drive a vehicle;
torque calculation means for calculating a torque required by a vehicle driver to control an output torque of the power source means;
speed detector means for detecting a travel speed of the vehicle; and
inclination estimation means for estimating an inclination of a road the vehicle travels based on the required torque and the travel speed.

2. The vehicle control system as in claim 1, further comprising:
pressure estimation means for estimating an atmospheric pressure based on a throttle position and an intake air pressure of an engine used as the power source means;
limit calculation means for calculating a limit based on the estimated inclination and a travel distance of the vehicle; and
guard means for guarding the estimated atmospheric pressure against deviation from the calculated limit.

3. The vehicle control system as in claim 1, wherein inclination estimation means estimates the inclination based on the required torque and a change in the travel speed.

4. The vehicle control system as in claim 3, wherein the inclination is calculated by using mapped data defining a relation among the inclination, the required torque and the change in the travel speed.

5. The vehicle control system as in claim 1, further comprising:
pressure estimation means for estimating an atmospheric pressure as a function of the estimated inclination, wherein the estimated atmospheric pressure is used to control an engine used as the power source means.

6. The vehicle control system as in claim 5, wherein the pressure estimation means estimates the atmospheric pressure by further using a throttle position and an intake air pressure of the engine.

7. A vehicle control system comprising:
an engine having an intake pipe;
a sensor provided in the intake pipe for detecting an intake parameter of the engine; and
an electronic control unit for controlling the engine based on at least the detected intake parameter and an atmospheric pressure,
wherein the electronic control unit is programmed to calculate:
a torque required by a vehicle driver;
a speed change of the vehicle;
an inclination of a travel road of the vehicle based on the required torque and the speed change;
a travel distance of the vehicle; and
the atmospheric pressure as a function of the inclination and the travel distance.

8. The vehicle control system as in claim 7, wherein the electronic control unit is further programmed to calculate:
an upper and lower limits based on the inclination and the travel distance;
the atmospheric pressure based on the detected intake parameter by limiting with the upper and lower limits.

9. The vehicle control system as in claim 8, wherein the intake parameter includes a throttle position and an intake air pressure.

10. The vehicle control system as in claim 7, wherein the electronic control unit calculates the required torque based on an accelerator position varied by the vehicle driver.
